(19) United States
(12) Patent Application Publication
(10) Pub. No.: US 2003/0061304 A1
(43) Pub. Date: Mar. 27, 2003

(54) Method and apparatus for discovering client proximity using in-line translations

(76) Inventors: Peter A. Tenereillo, Carlsbad, CA (US); William LeBlanc, Atlanta, GA (US); James A. Jordan, Roswell, GA (US); Richard A. Howes JR., Roswell, GA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/027,686

(22) Filed: Dec. 21, 2001

Related U.S. Application Data
(60) Provisional application No. 60/318,426, filed on Sep. 10, 2001.

(51) Int. Cl. G06F 15/16

(52) U.S. Cl. 709/217

(57) ABSTRACT

A system and method for determining a chronometrically optimal (most proximate) location for a client based on proximity measurements on established connections that are a result of requests for actual content is described. According to one embodiment, the method comprises retrieving data by one of a plurality of personal content directors each associated with a separate local domain. The data includes a plurality of relative links. The plurality of relative links are translated into a corresponding plurality of absolute links that collectively point to the local domains associated with the plurality of personal content directors. Thereafter, a most proximate local domain for a client is determined based on subsequent accesses to download data accessible through the absolute links.

This application claims the benefit of priority on U.S. Provisional Patent Application 60/318,426 filed Sep. 10, 2001.

### FIELD

The invention generally relates to the field of communications. More particularly, the invention relates to the management of traffic over a network.

### GENERAL BACKGROUND

As usage of the Internet has increased, various web sites have responded by adding such features as redundancy and load balancing. Accordingly, it has become important to direct a client to the geographically closest and least busy web site. The practice of dispersing data from a web site closer to the client is referred to as “client proximity” and has been widely accepted.

In an attempt to direct clients to the geographically closest and least busy web site, a number of techniques have been implemented. Current technologies that attempt to provide a measure of geographic distribution of Web requests rely primarily on Domain Name System (DNS) techniques; namely, techniques normally performed by a Domain Name System (DNS) server alone or in combination with other logic.

One prior technique is Round-Robin Domain Name System (DNS). This technique involves entering multiple IP addresses to represent a single DNS hostname. As clients resolve the hostname, DNS responds by cycling through the multiple listed IP addresses.

Another technique involves computation of routing metrics by the DNS server and these metrics being used to determine how far away a client is from various web sites forming the global domain. This allows the DNS server to answer a DNS request with a web site address associated with a local domain considered to be closest to the client. The primary DNS server can determine the distance from the client to each web site by counting network hops.

Another technique involves the use of a DNS server in conjunction with routers to approximate network distance to a web site from the requester. This technique is achieved through the announcement of a single IP address or a single set of IP addresses throughout the Internet resolving to a single hostname.

Yet another technique involves geographically distributed DNS servers that provide differing IP addresses on a per server basis. This technique is achieved through the announcement of a single IP address for authoritative DNS servers, which when queried may each provide a different response specifying the nearest web site.

While these DNS techniques provide some load sharing capabilities, they are inherently problematic because they are difficult and resource-intensive to resolve. In addition, the DNS solutions are incapable of being content aware and are, at best, useful in assisting a more robust approach by initially guiding a client to a web resource.

There are now attempts to develop a client proximity process using personal content directors (i.e. site selectors) in which clients are directed to “chronometrically optimal” locations, namely locations that provide the best overall response time, taking into account all factors including geographical distance, network topology (latency), server response time and the like. Exemplary client proximity processes are described in commonly-owned, U.S. patent application Ser. No. 09/728,305 (filed Nov. 30, 2000), entitled “Method and Apparatus For Discovering Client Proximity”. For instance, during “Image Insert” mode, the client proximity process avoids added latency associated with other processes, but does not avoid added network traffic.

### SUMMARY

One embodiment of the invention relates to a system and method for determining a chronometrically optimal location for a client based on proximity measurements on established connections that are a result of requests for actual content. Instead of adding transparent images or other types of objects to a downloaded web page, the links are altered to enable PCDs to compute return trip time (RTT) values and provide such values to the synchronizing PCD for subsequent selection of the optimal site.

### BRIEF DESCRIPTION OF THE DRAWINGS

The features and advantages of the invention will become apparent from the following detailed description of the invention in which:

FIG. 1 is an exemplary embodiment of a communication system utilizing personal content directors (PCDs) according to the invention.

FIG. 2 is an exemplary embodiment of a personal content director (PCD) of FIG. 1.

FIG. 3 is an exemplary flowchart of the operations conducted by a selected, synchronizing personal content director.

FIG. 4 is an exemplary embodiment of a HTML web page with a plurality of objects displayed thereon according to contents extracted by the synchronizing PCD.

FIG. 5 is an exemplary embodiment of a translation operation conducted by the synchronizing PCD.

FIG. 6 is an exemplary embodiment of an HTML web page with translated objects as received by the client from the synchronizing PCD.

FIG. 7 is an exemplary flowchart of the operations conducted by the client upon receiving the translated HTML web page from the synchronizing PCD as further shown in FIG. 1.

FIG. 8 is an exemplary embodiment of a communication system utilizing a load-balancing switching device to resolve a request into a virtual IP address (VIP) targeted for one of multiple personal content directors (PCDs).

FIG. 9 is an exemplary embodiment of an HTML web page with tagged objects as received by the client from the synchronizing PCD.

### DETAILED DESCRIPTION

In general, one embodiment of the invention relates to a system and method for determining a chronometrically optimal location for a client based on proximity measurements on established connections that are a result of requests for actual content. No transparent Graphic Interface Format (GIF) images or other types of objects are added to a downloaded web page.

Certain details are set forth below in order to provide a thorough understanding of the invention, albeit the invention may be practiced through many embodiments other that those illustrated. Well-known logic and operations are not set forth in detail in order to avoid unnecessarily obscuring the invention.

In the following description, certain terminology is used to describe certain features of the invention. For example, a “personal content director” or “PCD” is a computing device that is adapted to a network (e.g., the Internet) in order to optimize performance of domains hosted on geographically distributed, mirrored web sites. Normally, a PCD comprises internal logic, namely hardware, firmware, software module(s) or any combination thereof, having an architecture generally equivalent to a computer (e.g., server, desktop, laptop, hand-held, mainframe, or workstation), set-top box, or a network switching device such as a router, bridge or brouter.

A “client” is a computing device that executes Web Browser software to communicate over a network in order to download information from a web site. Such information may include HyperText Markup Language (HTML) web pages.

A “software module” is a series of instructions that, when executed, performs a certain function. Examples of a software module include an operating system, an application, an applet, a program or even a routine. One or more software modules may be stored in a machine-readable medium, which includes but is not limited to an electronic circuit, a semiconductor memory device, a read only memory (ROM), a flash memory, a type of erasable programmable ROM (EPROM or EEPROM), a floppy diskette, a compact disk, an optical disk, a hard disk, or the like.

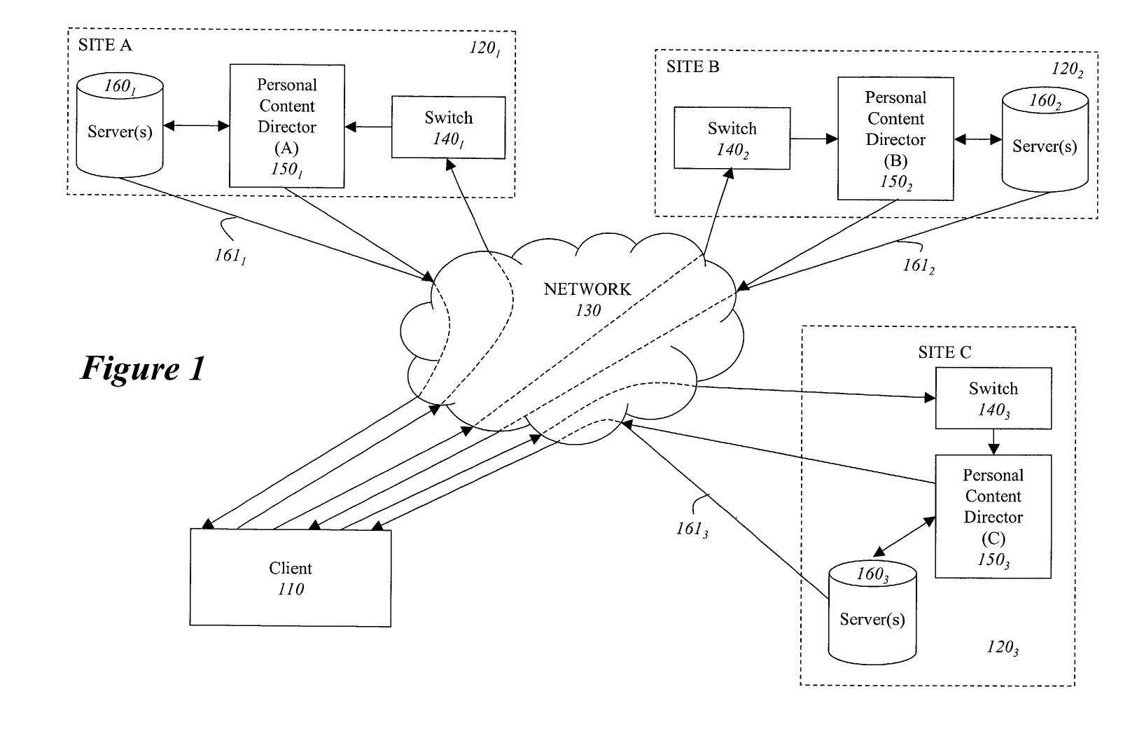

Referring to FIG. 1, an exemplary embodiment of a communication system utilizing personal content directors (PCDs) is shown. Herein, system (100) comprises a client 110 in communication with a plurality of geographically dispersed, fully replicated web sites 120₁-120_{N} over a network 130, where “N” is equal to three for this embodiment. Of course, other embodiments may exist with more than three replicated web sites (N≧4).

As shown, web site 120₁ includes a switching device 140₁ for routing information, a personal content director (PCDs) 150₁ and a server farm 160₁. A “server farm” is generally defined as a server or multiple servers operating in a collective manner. Similarly, web sites 120₂ and 120₃ include switching devices 140₂, 140₃; PCDs 150₂, 150₃ and server farms 160₂, 160₃, respectively.

During the client proximity selection process, each PCD 150₁-150₃ is adapted to operate as a proxy server to communicate requests by client 110 to one or more servers 160₁-160₃. During normal operations, however, the servers 160₁-160₃ are in communication with the client 110 over network 130 as shown by routing path 161₁-161₃. Moreover, each PCD 150₁-150₃ is further configured to communicate with each other and client 110 using appropriate Transmission Control Protocol (TCP) over network 130. For this embodiment, network 130 is any type of wide area network (WAN) such as the Internet. Of course, network 130 may be configured as a type of local area network (LAN) while still maintaining the spirit and scope of the invention.

Although not shown, system 100 further includes an authoritative Domain Name Server (DNS) that resolves (translates) an alphanumeric, web site domain name into addresses recognized by the PCDs 150₁-150₃. For the system 100, multiple distributed web sites 120₁-120₃ appear to be a single domain (referred to as a “global domain”). A global domain may be separated into multiple “real” web sites, each referred to herein as “local domains” and uniquely registered in DNS with a unique uniform resource locator (URL). To participate in the client proximity selection process, a PCD needs to be configured as a member of that local domain. Each PCD can have more than one global domain; a mirror web site can support more than one local domain; and a PCD can be a member of more than one local domain.

For example, in one embodiment, the web site domain “www.nortelnetworks.com” may be resolved into one of a plurality of IP addresses that is associated with a participating PCD 150₁-150₃ of web sites 120₁-120₃. These IP addresses are entered into DNS as the addresses for the web site domain as shown in Table 1. Such selection as to which IP address may be controlled by a round-robin determination for example.

TABLE 1

| DNS Name | Participant PCDs |
|---|---|
| www.nortelnetworks.com | PCD A, B, C |
| wwwa.nortelnetworks.com | 1.1.1.1 (PCD A) |
| wwwb.nortelnetworks.com | 2.2.2.2 (PCD B) |
| wwwc.nortelnetworks.com | 3.3.3.3 (PCD C) |

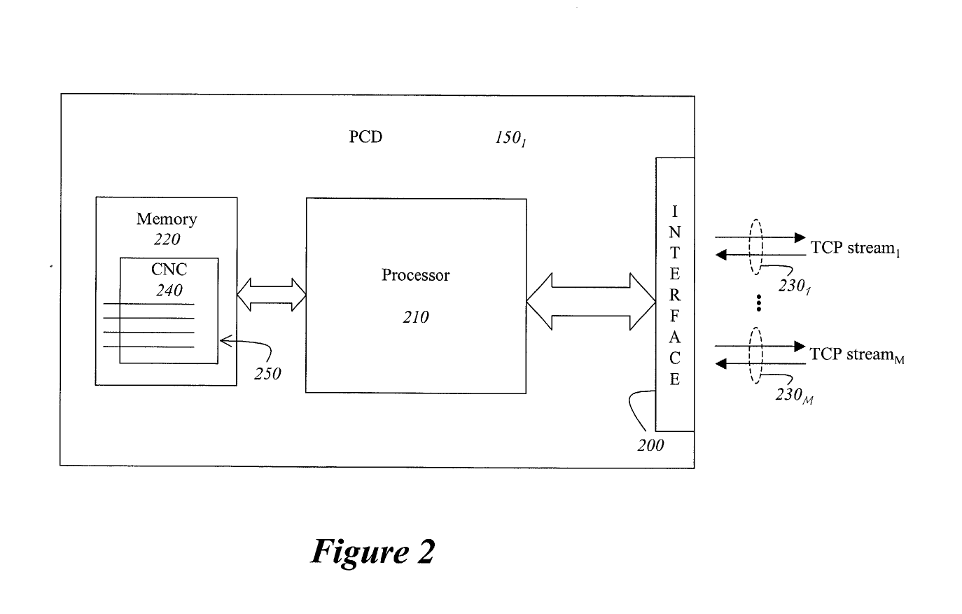

Referring now to FIG. 2, an exemplary embodiment of a personal content director (PCD) 150₁ of FIG. 1 is shown. PCD 150₁ comprises a network interface 200, a processor 210 and memory 220. Network interface 200 supports multiple TCP communication streams 230₁-230_{M}. One TCP stream 230₁ may be a Hypertext Transfer Protocol (HTTP) GET request in accordance with a client proximity selection process described below. Another TCP stream 230_{M} may be information regarding response time statistics transmitted in accordance with a message digest based (MD5) authenticated protocol running on TCP as set forth in commonly-owned, U.S. patent application Ser. No. 09/728,305 incorporated herewith by reference.

Processor 210 controls the retrieval of content from server(s) at the web site 120₁ of FIG. 1. Examples of processor 210 may include, but is not limited or restricted to a microprocessor, digital signal processor, application specific integrated circuit (ASIC), microcontroller, and the like.

Memory 220 is loaded with (i) software modules executable by processor 210 to support client proximity selection process operations of web site 120₁ and (ii) a client network cache (CNC) 240. CNC 240 is configured to store representations of client network addresses associated with client/local domain responses. Upon receiving an initial client request (e.g., HTTP GET request), PCD 150₁ acts as a synchronizing PCD.

Upon finding an entry 250 in its CNC 240, synchronizing PCD 150₁ would direct client 110 of FIG. 1 to the associated web site, thus avoiding data overhead for client proximity selection. CNC 240 can correlate user data based on DNS name of the client or IP address and compare this data to allow a client that has yet not established a connection with synchronizing PCD 150₁ to benefit from previous client connections. If no entry is found, however, synchronizing PCD 150₁ may enter into a particular mode of operation for the client proximity selection process referred to as an in-line translation (ILX) mode, described below.

To support in-line translation (ILX) mode, the IP address of each local domain and its subsequently computed return trip time (RTT) measurements are stored in one or the entries 250 of CNC 240. Each entry may also contain a date-stamp, which allows for deletion of entries that exceed administrator-specified time limits.

A. First Embodiment

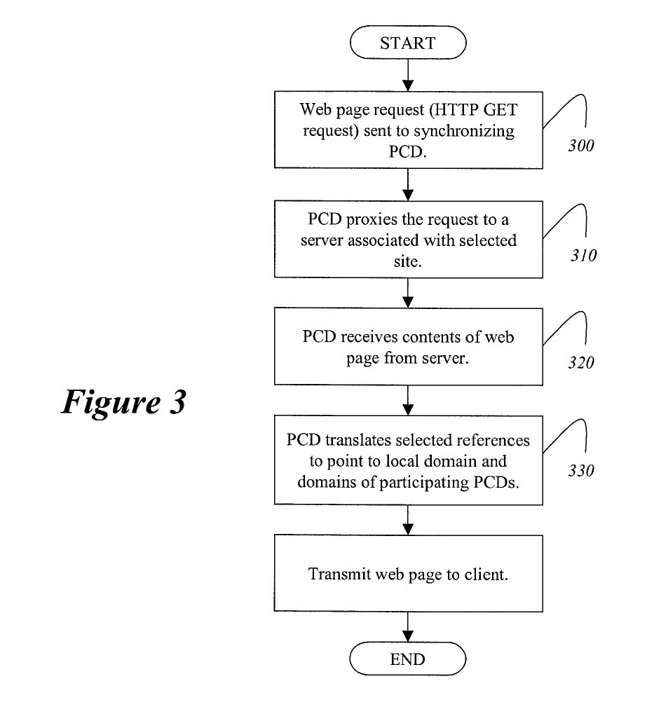

Referring now to FIG. 3, an exemplary flowchart of the operations conducted by a selected, synchronizing personal content director (PCD) (or software executed therein) is shown. Initially, during the client proximity process, a web page request (e.g., HTTP GET request) is received by a PCD, now referred to as the synchronizing PCD (block 300). As briefly stated above, the DNS server chooses the synchronizing PCD and forwards the web page request thereto.

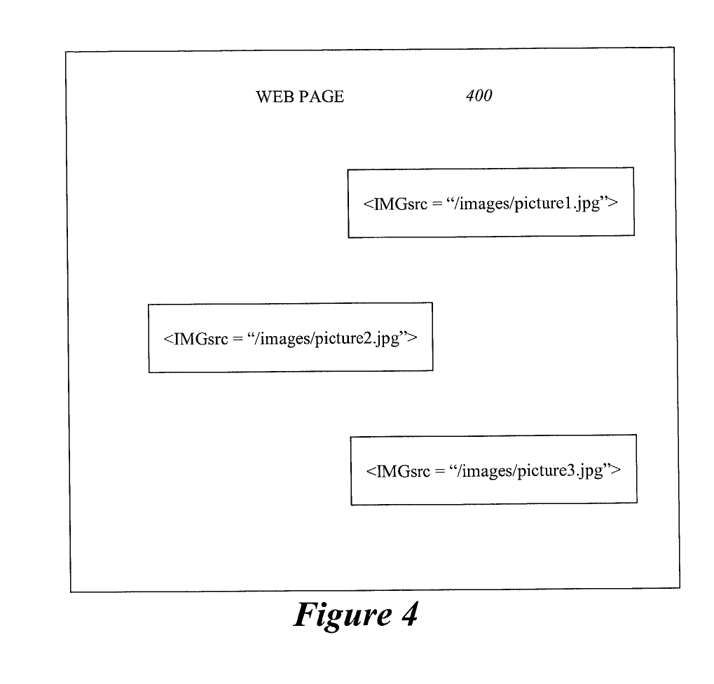

Upon receiving the request, the synchronizing PCD proxies server(s) of its Web site for requested content forming the Web page (block 310). For instance, the requested content may form a home page (default.html). The type of content may include text and images as shown in FIG. 4. For instance, the Web page 400 may include three selected references being images 410, 420 and 430 compressed in accordance with any compression function such as Joint Photographic Experts Group (JPEG) for example. Of course, the selected references may be other image types.

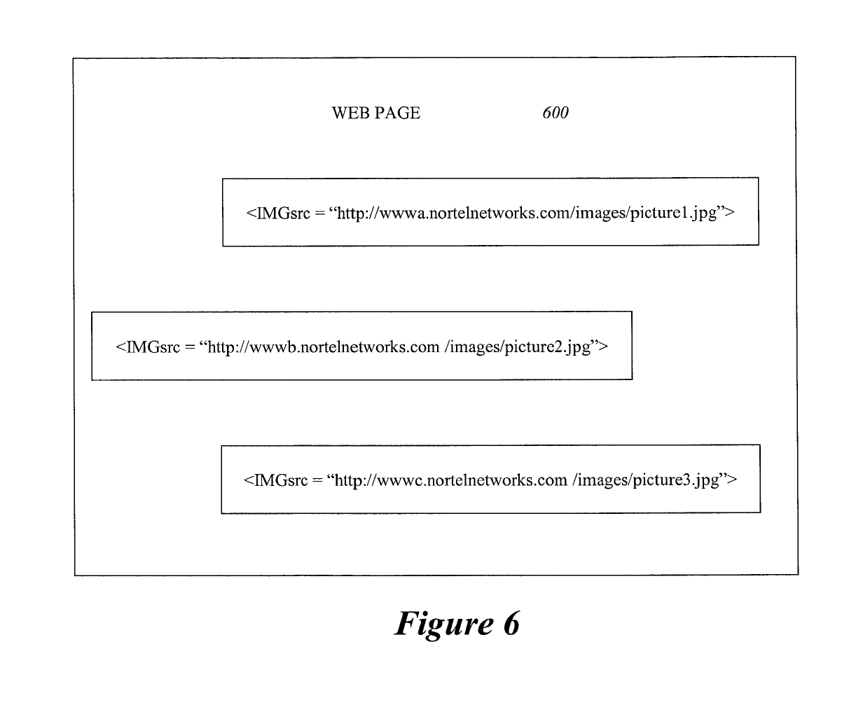

Referring to FIGS. 3, 5 and 6, as described in blocks 320 and 330, synchronizing PCD receives the content from the server(s) and translates selected references to point to its own local domain (wwwa.nortelnetworks.com) as well as other participating local domains (wwwb.nortelnetworks.com and wwwc.nortelnetworks.com). Thereafter, the translated HTML web page 600 of FIG. 6 is downloaded to the client (block 340).

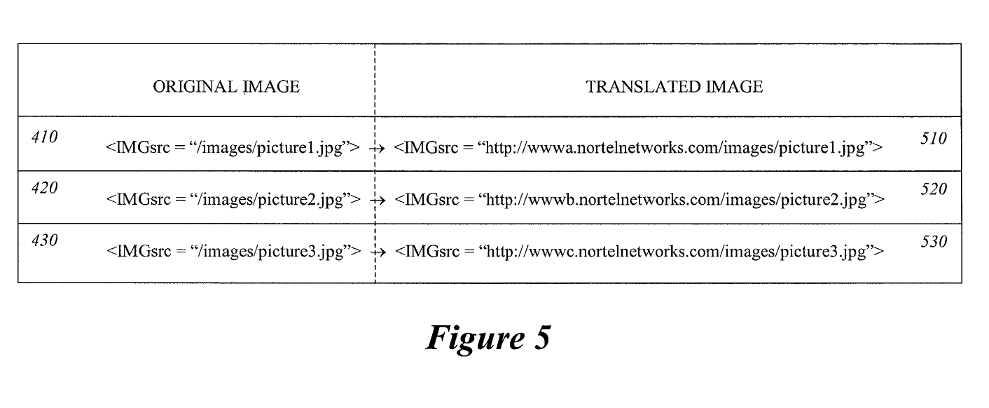

For instance, as shown in FIG. 5, first selected reference 410 is translated from its relative link “/images/picture1.jpg”, returning to a base URL (site A), into an absolute link 510 identified as the following:

“http://wwwa.nortelnetworks.com/images/picture1.jpg”. Similarly, second selected reference 420 is translated from relative link “/images/picture2.jpg” into an absolute link

“http://wwwb.nortelnetworks.com/images/picture2.jpg” (site B) and third selected reference 430 is translated from its relative link “/images/picture3.jpg” into absolute link

“http://wwwc.nortelnetworks.com/images/picture3.jpg” (site C).

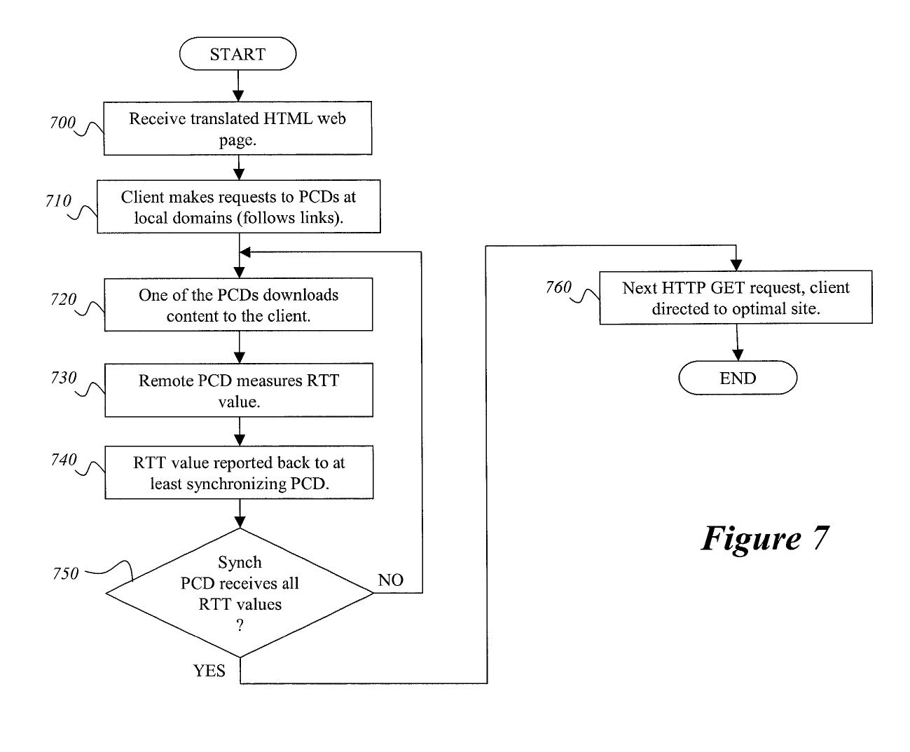

Referring now to FIG. 7, an exemplary flowchart of the operations conducted by the client upon receipt of the translated HTML web page and subsequent operations by the synchronizing PCD is shown. Upon receiving the translated HTML web page (block 700), which now includes absolute links, the client generally follows the links to remote sites and downloads images and other requested files. In addition, the remote PCDs conduct RTT measurements and report these RTT values back to the synchronizing PCD. For instance, RTT measurements may be accomplished by computing a time difference between the arrival of the HTTP GET request and the time of arrival of the final acknowledgement packet at the PCD. Thereafter, on the next HTTP GET request from the client, the synchronizing PCD will redirect the client to the most proximate site.

In particular, for one embodiment, the client makes requests to local domains for all participating PCDs (block 710). Such requests may be made to all participating PCDs, being inclusive or exclusive of the synchronizing PCD. It is exclusive if RTT measurements were conducted by the synchronizing PCD during download of the translated HTML web page. For this embodiment, the requests are made to all PCDs 150₁-150₃ of FIG. 1 including the synchronizing PCD.

Herein, as an exemplary illustration, the client makes a request to a remote PCD (e.g., PCD 150₂) to download an image (e.g., a JPEG image “picture2.jpg”). The remote PCD downloads the image to the client and measures the RTT value, which is stored within the CNC of the remote PCD (blocks 720 and 730). This RTT measurement may occur contemporaneously with the downloading of the image. The RTT value is then reported back to at least the synchronizing PCD and perhaps to all participating PCDs (block 740). Such reporting may be made over inter-box protocol (IBP) based communications being authenticated communications as described in U.S. patent application Ser. No. 09/728,305 incorporated herewith by reference. This process is repeated for all participating PCDs, the order in which these requests are completed is a design choice (block 750).

Thereafter, the participating PCDs for the global domain store the network address of the client. Upon the next GET HTTP request from the client, the client is directed to the optimal site through either DNS or HTTP redirect (block 760).

B. Second Embodiment Using PCD Tagging

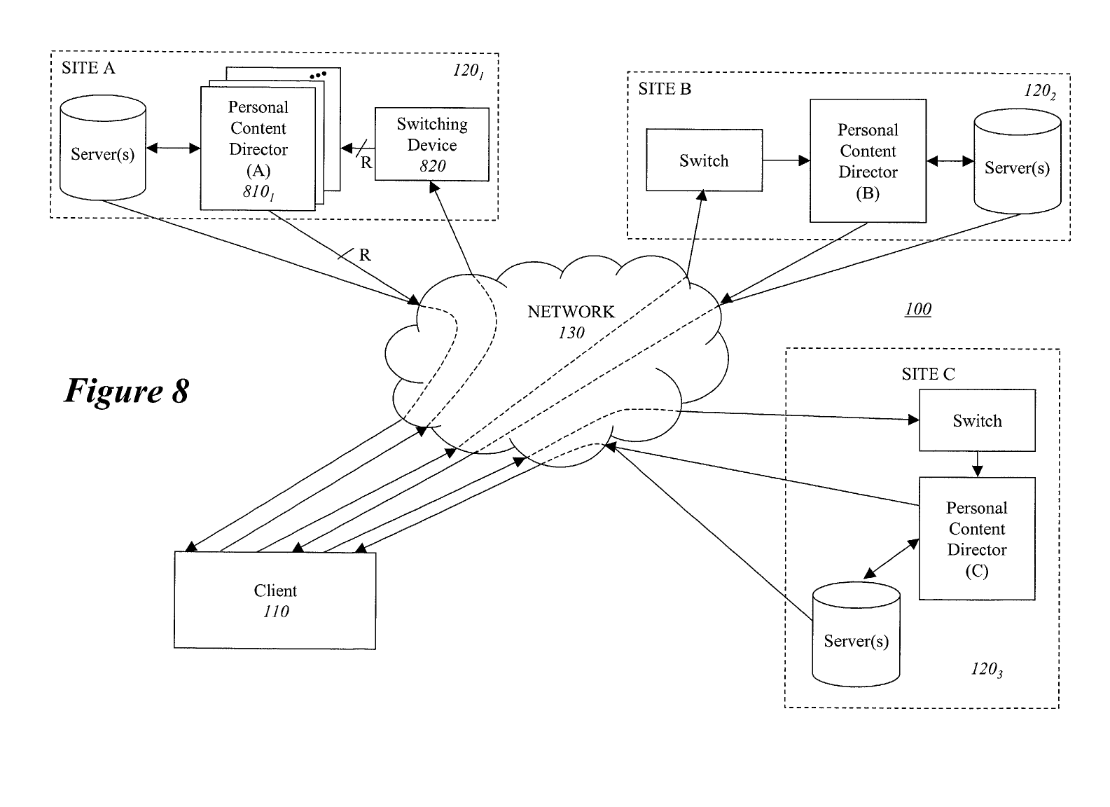

As shown, different IP addresses are used for the PCDs. However, as an alternative, multiple PCDs 810₁-810_{R} (R≧1) may be collectively coupled to a switching device 820 as shown in FIG. 8. For this embodiment, the DNS name wwwa.nortelnetworks.com resolves to a virtual IP address (VIP) on load-balancing switching device 820. Herein, the same VIP is used for the RTT measurements. This may be accomplished by placing a URL tag (e.g., an alphanumeric string) into the tagged (URL) link in such a manner that parsing rules followed by the load-balancing switching device 820 direct all requests that contain the URL tag to a PCD of the PCDs 810₁-810_{R}, rather than to the web server, media server, or whatever server from which the content originates.

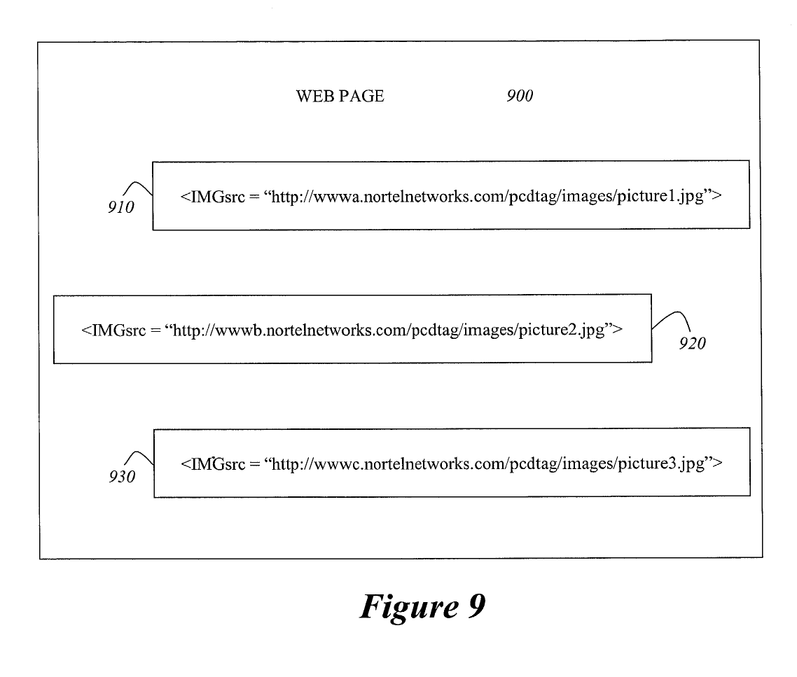

For example, similar to FIG. 6, the translated HTML web page 900 of FIG. 9 is downloaded to the client but includes tagged absolute links 910, 920 and 930 (referred to as “tagged links”). Namely, the first reference is translated from its relative link “ /images/picture1.jpg”, returning to a base URL (site A), into tagged link 910 identified as the following:

http://wwwa.nortelnetworks.com/

pcdtag/images/picture1.jpg.

Similarly, the second selected reference is translated from relative link “/images/picture2.jpg” into tagged link “http://wwwb.nortelnetworks.com/pcdtag/images/picture2.jpg” (920, site B) and the third selected reference is translated from relative link “/images/picture3.jpg” into tagged link “http://wwWc.nortelnetworks.com/pcdtag/images/picture3.jpg” (930, site C).

Upon receiving the translated HTML web page including tagged links, for one embodiment, the client generally issues requests to the local domains. Such requests may be made to switching devices of all participating PCDS, such as a request (http://wwwb.nortelnetworks.com/pcdtag/images/ picture2.jpg) to a remote PCD for downloading an image (e.g., a JPEG image “picture2.jpg”). The switching device 820 operates to detect the URL tag “pcdtag” and directs the request to one of the PCDs (e.g., PCD 810₁). The PCD 810₁ strips the URL tag and proxies the request to the server farm 830 associated with the PCD 810₁. The PCD 810₁ downloads the retrieved image to the client and measures the RTT value, which is stored within the CNC of the PCD 810₁ and the process continues as described above.

What is claimed is:

1. A method comprising:
retrieving data by one of a plurality of personal content directors each associated with a separate local domain, the data including a plurality of relative links;
translating the plurality of relative links into a corresponding plurality of absolute links that collectively point to the local domains associated with the plurality of personal content directors; and
determining a most proximate local domain for a client based on subsequent accesses to download data accessible through the absolute links.

2. The method of claim 1, wherein the determining of the most proximate local domain, comprises:
transmitting the data to the client;
measuring return trip time values by the plurality of personal content directors during the downloading of the data accessible through the absolute links; and
reporting the return trip time values to the one of the plurality of personal content directors.

3. The method of claim 2, wherein prior to reporting the return trip time trip values, the method further comprising:
storing the return trip time values in a client network cache of each of the plurality of personal content directors.

4. The method of claim 1, wherein prior to retrieving the data, the method further comprises:
initiating a HTTP GET request by the client; and
routing the HTTP GET request to the one of the plurality of personal content directors.

5. The method of claim 4, wherein the routing of the HTTP GET request is conducted by a domain name server.

6. The method of claim 2, wherein the measuring of the return trip time values by a first personal content director of the plurality of personal content directors includes computing a time difference between arrival of a HTTP GET request associated with a subsequent access to the first personal content director and arrival of a final acknowledgement packet at the first personal content director.

7. A personal content director comprising:
an interface;
a memory; and
a processor in communication with both the interface and the memory, the processor to (i) retrieve a web page including a plurality of relative links in response to an initial request by a client and (ii) translate the plurality of relative links into a corresponding plurality of absolute links that collectively point to a plurality of local domains, including a local domain associated with the personal content director, forming a global domain.

8. The personal content director of claim 7, wherein the memory includes a client network cache to store an Internet Protocol (IP) address and subsequently measured return trip time (RTT) values for each local domain.

9. The personal content director of claim 7, wherein the processor measures a return trip time (RTT) value experienced during a downloading of data associated with an absolute link pointing to the local domain.

10. The personal content director of claim 9, wherein the processor further transmits the measured RTT value to a synchronizing personal content director.

11. The personal content director of claim 9, wherein the processor further receives at least one measured RTT value from another remotely located personal content director during a communication session.

12. The personal content director of claim 9, wherein the return trip time value is measured by computing a time difference between (1) an arrival of a HTTP GET request that caused retrieval of data associated with the absolute link of the web page pointing to the local domain of the personal content director and (2) arrival of a final acknowledgement packet at the personal content director.

13. A network comprising:
a client to transmit a request for retrieval of a web page; and
at least two personal content directors (PCDs) capable of being in communication with the client, a first PCD of the at least two PCDs to (i) retrieve the web page having a plurality of relative links, (ii) translate the relative links into corresponding absolute links that uniquely point to local domains associated with the at least two PCDS, (iii) transmit the translated web page to the client, and (iv) measure a return trip time (RTT) value for handling a request to download data accessed by the absolute link directed to the local domain associated with the first PCD.

14. The network of claim 13, wherein a second PCD of the further measures a RTT value for handling a request to download data accessed by the absolute link directed to the local domain associated with the second PCD.

15. The network of claim 13, wherein the RTT value is measured by computing a time difference between (1) an arrival of the request to download data and (2) arrival of a final acknowledgement packet at the first PCD.

16. The network of claim 13 further comprising:
a domain name server to receive an initial request for retrieval of the web page and to route the initial request to the first PCD operating as a synchronizing PCD.

17. The network of claim 14, wherein the second PCD of the at least two PCDS transmits the RTT value measured by the second PCD to the first PCD.

18. The network of claim 17, wherein the first PCD determines a most proximate local domain to the client by comparing the RTT values measured by the at least two PCDs and selected the most proximate local domain being the local domain associated with one of the at least two PCDs measuring a RTT value with the shortest duration.

19. The network of claim 13, wherein each the plurality of absolute links translated by the first PCD are tagged links including a Uniform Resource Locator (URL) tag.

20. The network of claim 19 further comprising:
a switching device coupled to the at least two PCDs and in communication with the client, the switching device to detect the URL tag within the request to indicate that the request is intended for measuring the RTT value.
